(19) United States
(12) Patent Application Publication
(10) Pub. No.: US 2025/0269571 A1
(43) Pub. Date: Aug. 28, 2025

(54) SYSTEM FOR FORMING A CONTAINER PREFORM

(71) Applicant: AMCOR RIGID PACKAGING USA, LLC, Ann Arbor, MI (US)

(72) Inventors: Jin ZHANG, Ann Arbor, MI (US); Mary IRVING, East Lansing, MI (US); Kirk Edward MAKI, Tecumseh, MI (US); Aaron TEITLEBAUM, Sylvania, OH (US); G. David LISCH, Jackson, MI (US); Jonathan MCGURK, Toledo, OH (US); Michael T. LANE, Brooklyn, MI (US)

(21) Appl. No.: 18/859,666

(22) PCT Filed: Apr. 27, 2023
(86) PCT No.: PCT/US2023/020229

§ 371 Date: Oct. 24, 2024

Related U.S. Application Data
(60) Provisional application No. 63/336,473, filed on Apr. 29, 2022.

(51) Int. Cl. B29C 45/76; B29K 23/00; B29K 67/00; B29K 105/00; B29K 105/26; B29L 23/00

(52) U.S. Cl. CPC B29C 45/76; B29C 2945/76153; B29C 2945/7629; B29C 2945/76461; B29C 2945/76809; B29C 2945/76832; B29C 2945/76943; B29K 2023/065; B29K 2023/12; B29K 2067/003; B29K 2105/0032; B29K 2105/26; B29L 2023/22

(57) ABSTRACT

A method for forming a preform or part including the following: dispensing an initial amount of an additive and a thermoplastic resin into an injection molding machine; forming the preform or part by operating a molding machine to inject the thermoplastic resin and the additive at the initial amount into a mold of the preform or part; measuring realized visual parameters of the preform or part; comparing the realized visual parameters to the target visual parameters and determining whether the realized visual parameters are within a predetermined acceptable range of the target visual parameters; if the realized visual parameters are outside the predetermined acceptable range of the target visual parameters, adjusting the initial amount of the additive to a modified amount estimated to achieve the target visual parameters; and forming an additional preform or part by operating the injection molding machine to inject the thermoplastic resin and the additive at the modified amount into the mold of the preform or part.

### CROSS-REFERENCE TO RELATED PATENT APPLICATION

This application claims the benefit of U.S. Provisional Patent Application No. 63/336,473, filed on Apr. 29, 2022, the entire disclosure of which is incorporated herein by reference.

### FIELD

The present disclosure relates to a system for forming a preform that is configured to be molded into a container.

### BACKGROUND

This section provides background information related to the present disclosure, which is not necessarily prior art.

Thermoplastic containers are often formed by injection molding a preform into a mold of the container. The preform is itself formed by molding the preform into a preform mold. While existing systems for forming preforms are suitable for their intended use, they are subject to improvement. For example, with existing systems the visual aspects of the preform may change during the production run, and the color may be inconsistent. The present disclosure includes a system that improves visual consistency, and provides numerous additional advantages as set forth herein.

### SUMMARY

This section provides a general summary of the disclosure, and is not a comprehensive disclosure of its full scope or all of its features.

The present disclosure includes a method for forming a preform that is configured to be molded into a container. The method includes the following: determining target visual parameters for the preform; setting an initial amount of an additive that is estimated to achieve the target visual parameters; dispensing the initial amount of the additive and a thermoplastic resin into an injection molding machine; forming the preform by operating the injection molding machine to inject the thermoplastic resin and the additive at the initial amount into a preform mold configured to form the preform; measuring realized visual parameters of the preform with a sensor; comparing the realized visual parameters of the preform to the target visual parameters and determining whether the realized visual parameters are within a predetermined acceptable range of the target visual parameters using a control module configured to perform the comparing; if the realized visual parameters are within the predetermined acceptable range of the target visual parameters, identifying the preform as acceptable; if the realized visual parameters are outside the predetermined acceptable range of the target visual parameters, adjusting the initial amount of the additive to a modified amount estimated by the control module to achieve the target visual parameters; dispensing the modified amount of the additive and the thermoplastic resin into the injection molding machine; and forming an additional preform by operating the injection molding machine to inject the thermoplastic resin and the additive at the modified amount into the preform mold.

The present disclosure further includes a system for forming a preform that is configured to be molded into a container. A preform mold is configured to form the preform in an injection molding machine. A thermoplastic resin dispenser configured to dispense thermoplastic resin into the injection molding machine. An additive dispensing system configured to dispense an additive into the injection molding machine. A sensor configured to measure realized visual parameters of the preform. A control module is configured to: set target visual parameters for the preform; set an initial amount of the additive sufficient to achieve target visual parameters; control the thermoplastic resin dispenser to add the thermoplastic resin to the injection molding machine, control the additive dispensing system to add the additive to the injection molding machine at the initial amount, and control the injection molding machine to form the preform from the thermoplastic resin and the additive by injection molding; measure realized visual parameters of the preform with the sensor after the preform is injection molded; compare the realized visual parameters to the target visual parameters and determine whether the realized visual parameters are within a predetermined acceptable range of the target visual parameters; if the realized visual parameters are within the predetermined acceptable range of the target visual parameters, identify the preform as acceptable; if the realized visual parameters are outside the predetermined acceptable range of the target visual parameters, reset the initial amount of the additive to a modified amount estimated by the control module to achieve the target visual parameters; and control the thermoplastic resin dispenser to add the thermoplastic resin to the injection molding machine, control the additive dispensing system to add the additive to the injection molding machine at the modified amount, and control the injection molding machine to form another preform from the thermoplastic resin and the additive by injection molding.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a preform seated in a cooling tube proximate to a sensor configured to measure visual parameters of the preform;

FIG. 2 is a cross-sectional view of a finish area of the preform of FIG. 1; and

FIG. 3 illustrates features of a system in accordance with the present disclosure for controlling consistency of visual parameters of the preform;

FIG. 4A illustrates additional features of the system for controlling visual parameter consistency of the preform;

FIG. 4B illustrates further features of the system for controlling visual parameter consistency of the preform;

FIG. 5 illustrates exemplary components of the system for controlling visual parameter consistency of the preform; and

FIG. 6 is a graph showing advantages of the system for controlling visual parameter consistency of the present disclosure.

Corresponding reference numerals indicate corresponding parts throughout the several views of the drawings.

### DETAILED DESCRIPTION

Example embodiments will now be described more fully with reference to the accompanying drawings.

The present disclosure is directed to thermoplastic resin preforms/parisons and containers manufactured by a process known as blow molding. There are three main types of blow molding: extrusion blow molding; injection blow molding; and injection stretch blow molding. The blow molding process begins with injection molding a preform or extruding a parison, then softening the preform or parison with a heat source. The preform or parison is placed in a blow mold and formed into the final container shape with high pressure air. In Extrusion Blow Molding (EBM), thermoplastic is melted and extruded into a hollow tube, which is clamped in a mold and high pressure air inflates the parison into the shape of the final container. In Injection Blow Molding (IBM) the thermoplastic is injection molded onto a core pin then the core pin is rotated to a blow molding station to be inflated with high pressure air to form the shape of the final container. In Injection Stretch Blow Molding (ISBM), preforms are heated using infrared heaters above their glass transition temperature, then blow molded using high-pressure air into a final container. During blow molding, the preform is stretched with a core rod as part of the process. ISBM uses two different methods, referred to as on-step and two-step. In one-step ISBM, both the preform injection molding and container blow molding is performed in the same machine. In the two-step ISBM, the thermoplastic is first molded into a “preform” using the injection molding process. The preforms are later fed into a blow molding machine.

Virgin PET (polyethylene terephthalate), recycled PET (rPET), and other virgin and post-consumer recycled (PCR) thermoplastic resin is used to make injection molded preforms that are then blow molded into containers. During the injection molding production run, visual properties can shift over time. The visual properties can be adjusted by introducing various additives to the injection molding process. Additives may include colorant, toner, light blockers, UV inhibitors, scavengers, resin modifiers, mold release agents, or any other additive that can measured optically. This is typically done by manual adjustment of the amount of additive dosing to maintain visual consistency. Also, the various grades of resin, and specifically PCR, currently being used typically have an inconsistent visual appearance, such as yellow or brown color, for example. During injection molding of container preforms, the visual appearance of the preforms changes during the production run and is inconsistent due to the varying properties of the additive or PCR. This potentially comes from many different causes, such as, but not limited to, the following: the source of raw materials; the supplier of the additive or resin being used; inconsistent visual properties within resin lots; resin degradation during the injection molding process, such as over drying, etc.; and inconsistency in the blending of resin, PCR, and additives during the injection molding process.

When using rPET/PCR, the injection molded preforms may have a yellow/brown color. To make the preform and final container more aesthetic, typically additives that adjust the preform's visual characteristics are added during the injection molding process to make the preform/container have a more desirable appearance. Existing systems are set to a fixed level of additive based on the preform color at the time of color testing at the beginning of the injection molding production run. As the color shifts and changes due to the causes set forth above, the amount of additive must be adjusted to keep the color and other visual parameters within specification. The Yellowness Index (YI) is one reference measurement for monitoring color, for example. If changes in color are not detected quickly, discolorations can result in recalls for out of specification preforms because the color of the resin shifts too much during injection molding production, and the additive setting is not changed in time to correct the color shift.

In many facilities making preforms, including PCR preforms, the additive dosing system is set to a prescribed setting to prevent exceeding specified levels of YI. Previously machines would run and preforms would be gathered periodically through the day. The gathered preforms would then be tested at some time in the future. In the meantime, discolored preforms would continue to be produced. If the preforms were found to be out of specification, the preforms made at the time of the sampling would be put on hold and their color verified. Depending on how quickly the color changed, entire lots of partially good preforms would be scrapped.

Color and visual variability may also cause issues with converting the preform to a container. Change in the preform color and darkness (L* value) changes the reheating properties through the infra-red (IR) lamps of the blow molding machine. This creates an inconsistent energy absorption and final part temperature and an ultimate change in material distribution and final part mechanical properties such as top load, or visually differing areas in the final blow molded bottles.

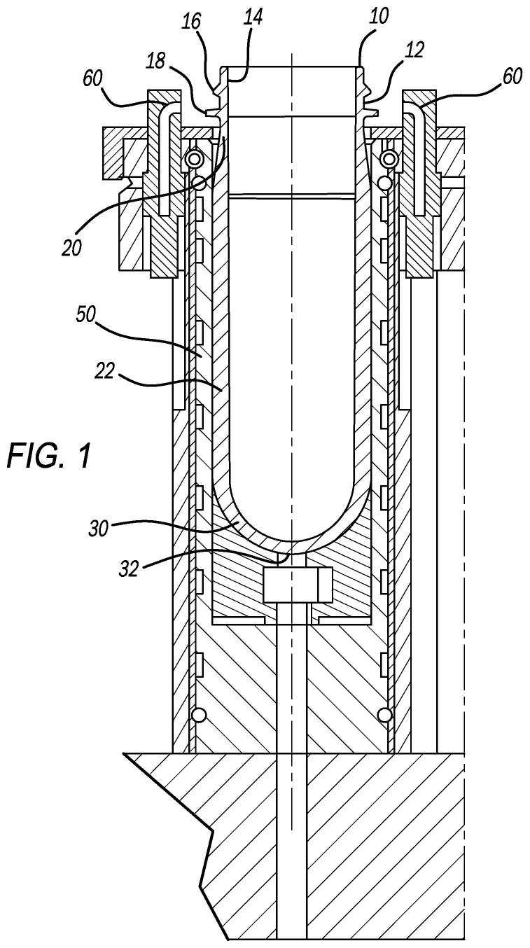

With respect to the present disclosure, FIG. 1 illustrates an exemplary preform 10. The preform 10 includes any suitable base thermoplastic resin, such as, for example, polyethylene terephthalate (PET), high density polyethylene (HDPE), polypropylene (PP), recycled resins (rPET, PCR), and blends of virgin and PCR resins. Included with the base resin is any suitable additive, such as a colorant.

The preform 10 includes a finish 12 defining an opening 14. At an outer surface of the finish 12 are threads 16, which are configured to cooperate with any suitable closure for closing a container blow molded from the preform 10. Also at an outer surface of the finish 12 is a support flange 18. Extending from the finish 12 is a neck and shoulder portion 20. Extending from the neck and shoulder portion 20 is a body 22. At an end of the preform 10 opposite to the opening 14 is a base portion 30 and a preform tip 32.

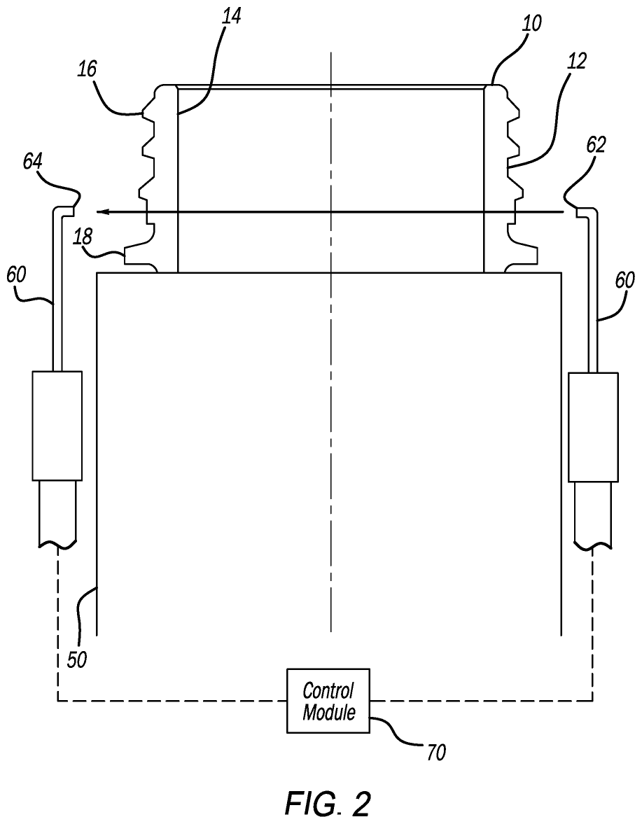

In the example of FIGS. 1 and 2, the preform 10 is seated in a cooling tube 50. The cooling tube 50 is part of the injection molding machine end of arm tooling (EOAT). The EOAT holds the cooling tubes 50, which are an integral part of it. The EOAT slides into the injection mold after it opens to remove the preforms before the mold closes again and makes another round of preforms. The EOAT cooling tube 50 is configured to facilitate cooling of the preform 10 after the preform 10 is molded. FIG. 1 also illustrates a sensor 60. The sensor 60 is any suitable sensor configured to measure visual properties of the preform 10, including color. The sensor 60 can also be located in any other suitable location such as the injection mold, end of arm tooling (EOAT), resin melt stream, preform conditioning tube, ejection station or outfeed conveyor. The sensor 60 can also be configured to measure a final blow molded container. The sensor 60 can further include a plurality of sensors. When the preform 10 is seated in the EAOT cooling tube 50, relative visual measurements are taken through the finish 12, the neck/shoulder portion 20, the body 22, or any other suitable area of the preform 10. In the configuration illustrated, the visual measurements are taken through the finish 12 because the finish 12 remains substantially constant throughout the process of molding the preform 10 into a container. The preform “A” band may be targeted for visual measurement because it typically provides the clearest light signal with as little signal loss as possible from geometry, such as threads that scatter light. The visual measurements can be taken through both walls of the preform 10, or through only one wall. The sensor 60 may be in the form of a solid-state detector using visible, ultraviolet, or infra-red light and fiber optic cables, for example. One fiber optic cable 62 provides the light, and the other fiber optic cable 64 receives the light. The sensor 60 is configured to break the light down into values that can be used/converted into standard color evaluation values and sent to a control module 70. The sensor 60 and the control module 70 may be configured to use the CIELAB Color Space values of a*, b*, L* and a calculated YI value for comparison against the PLC values. L* corresponds to “perceptual lightness control,” and YI, a*, and b* correspond to “hue control.” Other suitable sensor systems may include X-ray, gamma, radio, and ultrasonic sensors, for example.

In this application, including the definitions below, the term “control module” may be replaced with the term “circuit.” The term “control module” may refer to, be part of, or include processor hardware (shared, dedicated, or group) that executes code (including code representing operational algorithms of the control module) and memory hardware (shared, dedicated, or group) that stores code (including code representing operational algorithms of the control module) executed by the processor hardware. The code is configured to provide the features of the control module 70 and the various systems and methods described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

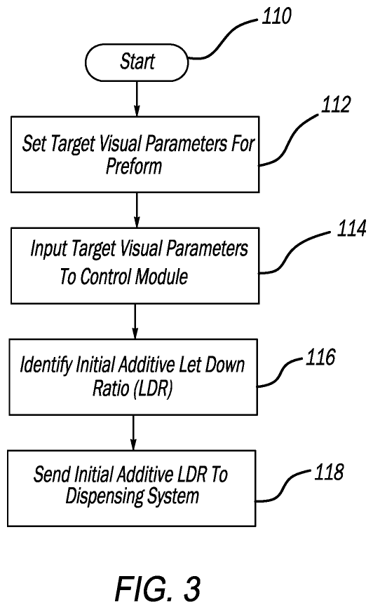

With continued reference to FIGS. 1 and 2, and additional reference to FIGS. 3, 4A, 4B, and 5, a system and method in accordance with the present disclosure for monitoring and modifying color parameters of the preform 10 during production will now be described. With particular reference to FIG. 3, a system and method for setting target color parameters begins at block 110. At block 112, target visual parameters for the preform 10 are set. The target parameters include, but are not limited to the colors of the CIELAB color space, also referred to as L*a*b*, which is a color space defined by the International Commission on Illumination (abbreviated CIE). L* represents perceptual lightness. a* and b* represent the four unique colors of human vision: red, green, blue, and yellow. Other possible color space variables include X, Y, Z, and R, G, B. The target visual parameters further include the yellowness index YI. L* is known as the “perceptual lightness control,” and YI, a*, and b* are known as “hue control.” Additional visual parameters can include tint, opacity, haze that can be a result of crystallinity of the injection molded preform, and the presence or absence of multiple layers of material within the preform. The target parameters may be set to match the parameters of a sample preform or a sample container, the visual parameters of which are measured in any suitable manner, such as by using a sensor similar to the sensor 60. The visual parameters of the sample preform or sample container are measured at the same location where the sensor 60 measures visual parameters of the preform 10, such as at the finish 12 or at the neck/shoulder portion 20. The target parameters may also be supplied by a customer as a numerical value, for example.

At block 114, the target visual parameters are input to the control module 70 in any suitable manner using any suitable interface. Any suitable human-machine interface may be included, such as any suitable touch screen, keypad, keyboard, etc. The target visual parameters may include, but are not limited to, the colors of the CIELAB color space (L*a*b*) and the yellowness index YI.

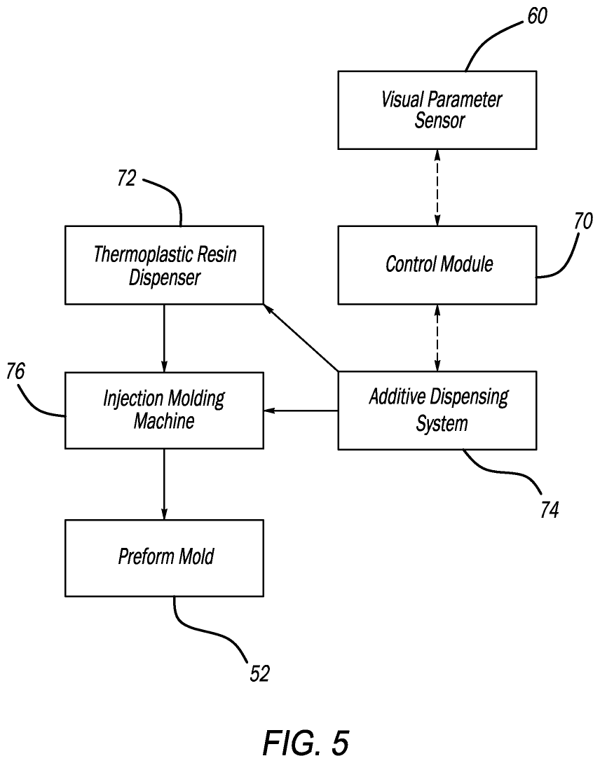

The control module 70 is configured to identify an initial additive amount in terms of a “let down ratio” (LDR) based on the target visual parameters, and at block 116 the control module 70 identifies the initial additive LDR. The additive LDR is the percentage of additive included with the base thermoplastic resin used to form the preform. The base thermoplastic resin may be any suitable injectable thermoplastic resin, such as polyethylene terephthalate (PET), high density polyethylene (HDPE), or polypropylene (PP) for example. The base resin may be 100% virgin resin, 100% recycled resin such as PCR PET, for example, or any suitable blend of virgin and recycled content. The base resin may also include additives such as colorant or processing aids for example. At block 118, the control module 70 transmits the initial additive LDR to the additive dispensing system 74 (FIG. 5). In some applications, the control module 70, the sensor 60, and the additive dispensing system 74 are integrally connected

Thermoplastic resin is fed into an injection molding machine 76, which injects the molten resin into a preform mold 52 for forming the preform 10. The preform mold 52 may be configured to produce a plurality of preforms at the same time. For example, the preform mold 52 may include multiple cavities that mold forty-eight or more preforms simultaneously. The term preform used throughout this disclosure can mean at least one preform.

The control module 70 is configured to control the additive dispensing system 74 to dispense the additive into the injection molding machine 76 at the additive let down ratio (LDR) predicted to produce a preform 10 and subsequent container having an acceptable visual appearance. The control module 70 may also be configured to control the additive dispensing system 74 to dispense the additive into the thermoplastic resin before it is fed into the injection molding machine at the additive let down ratio (LDR) predicted to produce a preform 10 and subsequent container having an acceptable visual appearance. The additive can be dispensed into the injection molding machine 76 at any suitable location such as the screw or at least one feed throat of the machine prior to being mixed with the base resin, or the additive can be blended with the base resin. The control module 70 is further configured to operate and receive inputs from the sensor 60. The inputs, as described herein, identify visual properties of the preform 10 as measured by the sensor 60. Based on the visual inputs, the control module 70 is configured to modify the additive let down ratio (LDR) to a level that the control module 70 determines will result in a preform 10 and container with an acceptable visual appearance. The control module 70 is configured to determine the optimized additive LDR by comparing measured visual parameter data of the preform 10 to the reference preform visual parameters. The control module 70 is configured to calculate a new optimized additive amount estimated to achieve the visual parameters of the reference preform within an acceptable range. The control module 70, the resin dispenser 72, and/or the dispensing system 74 may be configured with remote wireless communication capabilities to allow for remote connectivity for transmission of data for process monitoring, and receiving remote instructions and commands.

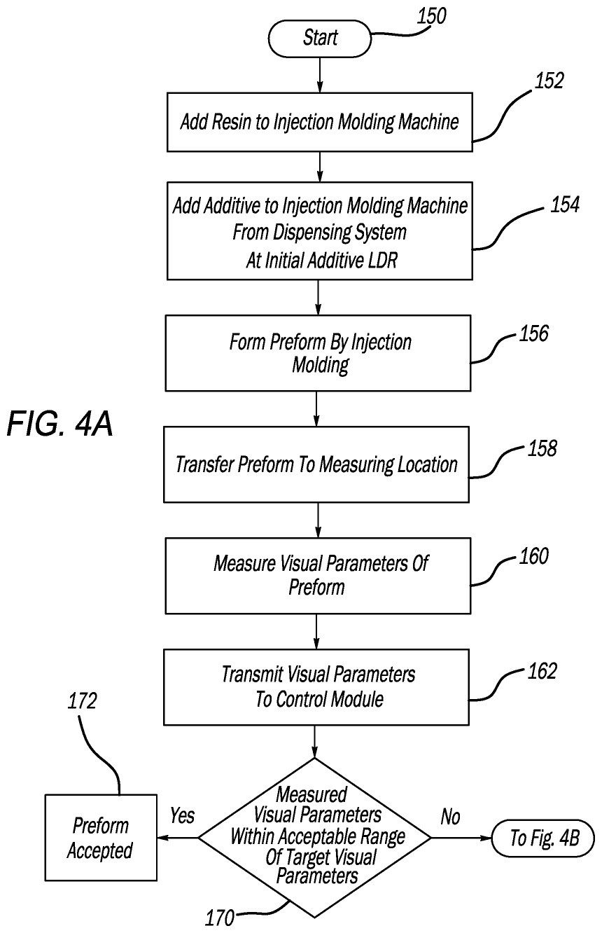

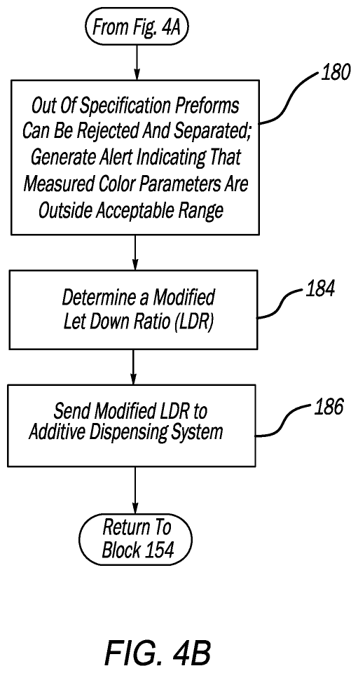

With reference to FIGS. 4A, 4B, and 5, the system and method for monitoring and modifying visual parameters of the preform 10 includes forming the preform 10 starting at block 150. At block 152, the control module 70 activates a thermoplastic resin dispenser 72 (FIG. 5) to dispense the base thermoplastic resin into the injection molding machine 76 for forming the preform 10. The thermoplastic resin may include, for example, PET. Dried PET, for example, flows out of a dryer of the dispenser 72, and at block 154 additive from the additive dispenser 74 is added at the initial additive LDR to the PET between the dryer and the feed throat of the extruder of the injection molding machine 76. The mixture of PET and the additive then flows to the preform mold. The mixture may include PCR resin and additional additives such as color or processing aids.

The present disclosure includes a dosing system for liquid additives being dispensed through a peristaltic pump or a progressive cavity pump using an output controlled by a servo or other precise rotation system. The peristaltic lobe numbers are maximized to increase granularity of accuracy while minimizing variation. The additive may also be mixed by a blender system or fed directly into the at least one feed throat of the injection molding machine 76. Alternatively, the additive may also be in pellet form. The additive is processed with the thermoplastic resin.

At block 156, the preform 10 is molded in a preform mold from the mixture of the additive and PET (and optionally PCR or other thermoplastic resins). From the preform mold, the preform 10 is transferred to the EOAT cooling tube 50 at block 158 in any suitable manner, such as with an end of arm cooling tool (EOAT). While in the EOAT cooling tube 50, at block 160 the sensor 60 takes visual measurements through the finish 12, the neck/shoulder portion 20, or at any other suitable location of the preform 10. The measurements can be taken through both walls of the preform 10, or through only one wall, or reflected off of the surface of the preform. In the example of FIG. 2, the visual measurements are taken through the finish 12. As described above, the sensor 60 is configured to measure the CIELAB visual space values (L*a*b*) and the yellowness index YI. At block 162, the measured visual parameters are input to the control module 70 from the sensor 60.

At block 170, the control module 70 compares the measured visual parameters to the target visual parameters. If the measured visual parameters fall within an acceptable predetermined range of the target visual parameters, then the control module 70 determines that the measured preform 10 is acceptable, and at block 172 the preform 10 is deemed accepted. If at block 170 the control module 70 determines that the measured visual parameters are not within an acceptable range of the target visual parameters, then at block 180 of FIG. 4B the preform 10 is rejected.

At block 182, the control module 70 is configured to generate an alert indicating that the measured visual parameters are outside of the acceptable range of the target visual parameters. Any suitable alert may be generated, such as any suitable audio, visual, text or email alert. At block 184, the control module 70 is configured to determine an optimized additive let down ratio (LDR) that will result in a preform 10 having measured visual parameters that are within an acceptable range of the target visual parameters. At block 186, the control module 70 is configured send the adjusted additive LDR to the additive dispensing system 74. The process then returns to block 152, and at block 154 the control module 70 operates the additive dispensing system 74 to dispense the additive at the adjusted additive LRD. From block 154, the system and method for monitoring and modifying visual parameters of the preform 10 repeats, but with the revised additive LDR. The system and method will continue to repeat and the control module 70 will continue to revise the additive LDR until the visual parameters measured by the sensor 60 are within an acceptable range of the target visual parameters.

The control module 70 is configured to adapt based on the outcome of the visual parameters of a new resin or additive, or change in current resin or additive, and will recalculate the additive let down values needed to maintain the desired target visual parameter values. The control module 70 is thus considered self-learning and self-tuning. This optimizes the additive based on the current resin or changes to resin attributes being run resulting in quick and precise control of the visual characteristics of the preform and final container.

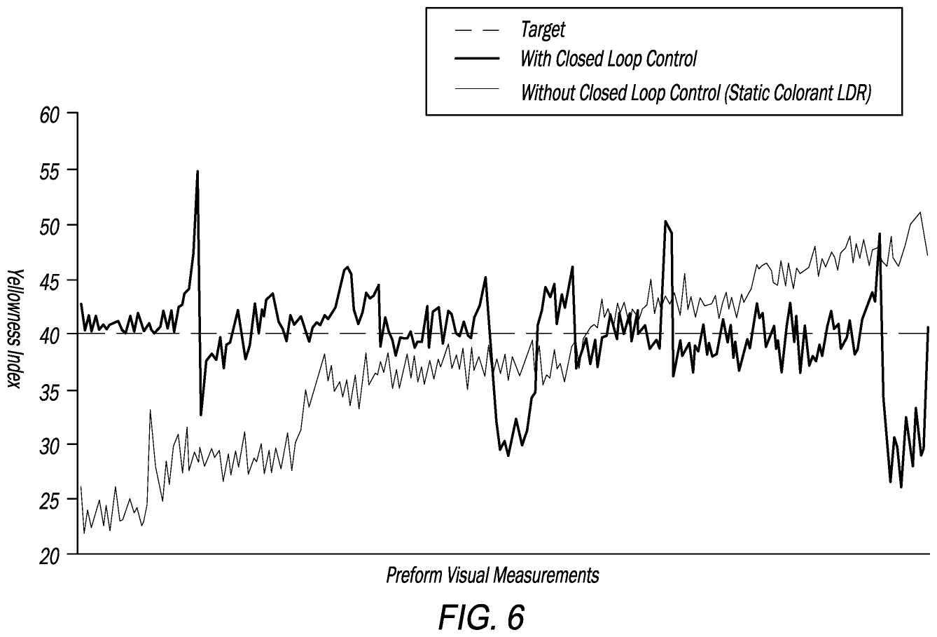

FIG. 6 is a graph of the yellowness index (an exemplary visual parameter) of exemplary preforms formed in accordance with the visual parameter controls of the present disclosure, versus the yellowness index of preforms formed without using the visual parameter controls of the present disclosure. As shown in FIG. 6, preforms formed in accordance with the present disclosure have a yellowness index that is more consistently closer to, and at, the target index of 45 as compared to preforms not formed in accordance with the present disclosure.

The present disclosure provides numerous additional advantages. Exemplary advantages include, but are not limited to, the following: reduced labor required to monitor visual consistency and adjust the dosing additive let down ratio (LDR); reduction of rejected molded preforms; and reduced additive usage by controlling the visual variations in real-time. Additional advantages include, but are not limited to, the following: continuous (or semicontinuous) monitoring of the preform 10 for visual quality; closed loop feedback to minimize visual variation; minimized visual variation for secondary process concerns—blowing; and final part resin distribution. The present teachings are also applicable to a number of additional uses including, but not limited to, the following: gloss detection (HDPE preforms); visual correction other than YI/PCR issues; use of surface measurement for opaque visuals; haze correction; UV block detection; END conveyor sorting, etc.

The present disclosure is not limited to preforms and containers. The present disclosure can be directed to additional embodiments such as a process for monitoring and adjusting/stabilizing visual consistence of any injection molded thermoplastic part or component, such as a closure for a container, for example. Thus, throughout this disclosure the term “preform” may be replaced with any suitable injection molded thermoplastic part or component including, but not limited to, a closure for a container.

The present disclosure includes a process for monitoring and adjusting/stabilizing the visual consistency in a manufacturing process with inherent visual variability, including but not limited to PCR, using a closed-loop system. This is done by determining the visual attributes desired, measuring the manufactured part while still in the machine and under control and comparing to the established reference value. If the visual is not within the set limits, a control module 70 checks the reading against the baseline and adjusts the visual dispensing into the resin using an algorithm. This is continuously active during the manufacturing process.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for forming a preform that is configured to be molded into a container, the method comprising:
determining target visual parameters for the preform;
setting an initial amount of an additive that is estimated to achieve the target visual parameters;
dispensing the initial amount of the additive and a thermoplastic resin into an injection molding machine;
forming the preform by operating the injection molding machine to inject the thermoplastic resin and the additive at the initial amount into a preform mold configured to form the preform;
measuring realized visual parameters of the preform with a sensor;
comparing the realized visual parameters of the preform to the target visual parameters and determining whether the realized visual parameters are within a predetermined acceptable range of the target visual parameters using a control module configured to perform the comparing;
if the realized visual parameters are within the predetermined acceptable range of the target visual parameters, identifying the preform as acceptable;
if the realized visual parameters are outside the predetermined acceptable range of the target visual parameters, adjusting the initial amount of the additive to a modified amount estimated by the control module to achieve the target visual parameters;
dispensing the modified amount of the additive and the thermoplastic resin into the injection molding machine; and
forming an additional preform by operating the injection molding machine to inject the thermoplastic resin and the additive at the modified amount into the preform mold.

2. The method of claim 1, wherein the control module, the sensor, and an additive dispensing system configured to dispense the additive are integrally connected.

3. The method of claim 1, wherein the thermoplastic resin includes polyethylene terephthalate (PET).

4. The method of claim 1, wherein the thermoplastic resin further includes post-consumer recycled (PCR) resin.

5. The method of claim 1, wherein the sensor is configured to measure the realized visual parameters through a finish of the preform.

6. The method of claim 1, wherein the sensor is configured to measure the realized visual parameters through a body of the preform.

7. The method of claim 1, wherein the sensor is configured to measure the realized visual parameters through at least one wall of the preform.

8. The method of claim 1, wherein the sensor is a solid-state light sensor including an emitter and a receiver.

9. The method of claim 1, wherein the sensor is configured to detect visible, ultraviolet, or infra-red light.

10. The method of claim 1, wherein the sensor uses fiber optic cables to transmit and receive light.

11. The method of claim 1, wherein the realized visual parameters include the following color space values: (L*a*b*) and a yellowness index (YI).

12. The method of claim 1, further comprising transferring the preform to a cooling tube and measuring the realized visual parameters.

13. The method of claim 1, wherein the target visual parameters correspond to reference visual parameters.

14. The method of claim 1, further comprising dispensing the additive into the injection molding machine at a screw or at least one feed-throat of the injection molding machine.

15. The method of claim 1, further comprising dispensing the additive directly into the thermoplastic resin.

16. The method of claim 1, wherein measuring the realized visual parameters of the preform is performed at one of the following locations: the injection molding machine; end of arm tooling; or a conveyor.

17. The method of claim 1, further comprising mixing the additive and the thermoplastic resin in the injection molding machine before forming the preform.

18. The method of claim 1, wherein the preform mold is configured for simultaneously molding at least forty-eight preforms.

19. The method of claim 1, wherein the additive is a colorant.

20. The method of claim 1, wherein the sensor is configured to measure the realized visual parameters by reflecting a light off of the preform.

21. The method of claim 1, wherein the thermoplastic resin includes high density polyethylene (HDPE).

22. The method of claim 1, wherein the thermoplastic resin includes high polypropylene (PP).

23. The method of claim 1, further comprising continuously comparing the realized visual parameters of subsequent performs formed by the injection molding machine to the target visual parameters, and determining whether the realized visual parameters of subsequent preforms are within the predetermined acceptable range of the target visual parameters using the control module.

24. The method of claim 23, further comprising the following: if the realized visual parameters of any of the subsequent preforms are outside the predetermined acceptable range of the target visual parameters, further adjusting the additive to a further modified amount estimated by the control module to achieve the target visual parameters.

25. A system for forming a preform that is configured to be molded into a container, the system comprising:
a preform mold configured to form the preform in an injection molding machine;
a thermoplastic resin dispenser configured to dispense thermoplastic resin into the injection molding machine;
an additive dispensing system configured to dispense an additive into the injection molding machine;
a sensor configured to measure realized visual parameters of the preform; and
a control module configured to:
set target visual parameters for the preform;
set an initial amount of the additive sufficient to achieve target visual parameters;
control the thermoplastic resin dispenser to add the thermoplastic resin to the injection molding machine, control the additive dispensing system to add the additive to the injection molding machine at the initial amount, and control the injection molding machine to form the preform from the thermoplastic resin and the additive by injection molding;
measure realized visual parameters of the preform with the sensor after the preform is injection molded;
compare the realized visual parameters to the target visual parameters and determine whether the realized visual parameters are within a predetermined acceptable range of the target visual parameters;
if the realized visual parameters are within the predetermined acceptable range of the target visual parameters, identify the preform as acceptable;
if the realized visual parameters are outside the predetermined acceptable range of the target visual parameters, reset the initial amount of the additive to a modified amount estimated by the control module to achieve the target visual parameters; and
control the thermoplastic resin dispenser to add the thermoplastic resin to the injection molding machine, control the additive dispensing system to add the additive to the injection molding machine at the modified amount, and control the injection molding machine to form another preform from the thermoplastic resin and the additive by injection molding.

26. The system of claim 25, wherein the control module, the sensor, and the additive dispensing system are integrally connected.

27. The system of claim 25, wherein the control module is configured to wirelessly communicate with at least one of the thermoplastic resin dispenser, the sensor, and the additive dispensing system.

28. The system of claim 25, wherein the thermoplastic resin includes polyethylene terephthalate (PET).

29. The system of claim 25, wherein the thermoplastic resin further includes post-consumer recycled (PCR) resin.

30. The system of claim 25, wherein the sensor is configured to measure the realized visual parameters through a finish of the preform.

31. The system of claim 25, wherein the sensor is configured to measure the realized visual parameters through a body of the preform.

32. The system of claim 25, wherein the sensor is configured to measure the realized visual parameters through at least one wall of the preform.

33. The system of claim 25, wherein the sensor is a solid state sensor including an emitter and a receiver.

34. The system of claim 25, wherein the sensor is configured to detect visible, ultraviolet, or infra-red light.

35. The system of claim 25, wherein the sensor uses fiber optic cables to transmit and receive light.

36. The system of claim 25, wherein the realized visual parameters include the following color space values: (L*a*b*) and a yellowness index (YI).

37. The system of claim 25, further comprising transferring the preform to a cooling tube and measuring the realized visual parameters.

38. The system of claim 25, wherein the target visual parameters correspond to reference visual parameters.

39. The system of claim 25, wherein the thermoplastic resin dispenser is configured to dispense the additive into the injection molding machine at a screw or at least one feed-throat of the injection molding machine.

40. The system of claim 25, further comprising dispensing the additive directly into the thermoplastic resin.

41. The system of claim 25, wherein the sensor is configured to measure the realized visual parameters of the preform at one of the following locations: the injection molding machine; end of arm tooling; and a conveyor.

42. The system of claim 25, wherein the injection molding machine is configured to mix the additive and the thermoplastic resin before forming the preform.

43. The system of claim 25, wherein the preform mold is configured for simultaneously molding at least forty-eight preforms.

44. The system of claim 25, wherein the additive is a colorant.

45. The system of claim 25, wherein the sensor is configured to measure the realized visual parameters by reflecting a light off of the preform.

46. The system of claim 25, wherein the thermoplastic resin includes high density polyethylene (HDPE).

47. The system of claim 25, wherein the thermoplastic resin includes high polypropylene (PP).

48. The system of claim 25, wherein the control module is further configured to continuously compare the realized visual parameters of subsequent performs formed by the injection molding machine to the target visual parameters, and determine whether the realized visual parameters of subsequent preforms are within the predetermined acceptable range of the target visual parameters.

49. The system of claim 48, wherein if the realized visual parameters of any of the subsequent preforms are outside the predetermined acceptable range of the target visual parameters, the control module is configured to adjust the additive to a further modified amount estimated by the control module to achieve the target visual parameters.

50. A system for forming an injection molded part, the system comprising:
an injection mold configured to form the injection molded part in an injection molding machine;
a thermoplastic resin dispenser configured to dispense thermoplastic resin into the injection molding machine;
an additive dispensing system configured to dispense an additive into the injection molding machine;
a sensor configured to measure realized visual parameters of the injection molded part; and
a control module configured to:
set target visual parameters for the injection molded part;
set an initial amount of the additive sufficient to achieve target visual parameters;
control the thermoplastic resin dispenser to add the thermoplastic resin to the injection molding machine, control the additive dispensing system to add the additive to the injection molding machine at the initial amount, and control the injection molding machine to form the injection molded part from the thermoplastic resin and the additive by injection molding;
measure realized visual parameters of the injection molded part with the sensor after the injection molded part is injection molded;
compare the realized visual parameters to the target visual parameters and determine whether the realized visual parameters are within a predetermined acceptable range of the target visual parameters;
if the realized visual parameters are within the predetermined acceptable range of the target visual parameters, identify the injection molded part as acceptable;
if the realized visual parameters are outside the predetermined acceptable range of the target visual parameters, reset the initial amount of the additive to a modified amount estimated by the control module to achieve the target visual parameters; and
control the thermoplastic resin dispenser to add the thermoplastic resin to the injection molding machine, control the additive dispensing system to add the additive to the injection molding machine at the modified amount, and control the injection molding machine to form another part from the thermoplastic resin and the additive by injection molding.

51. The system of claim 50, wherein the control module, the sensor, and the additive dispensing system are integrally connected.

52. The system of claim 50, wherein the part is a closure for a container.

53. The system of claim 50, wherein the control module is configured to wirelessly communicate with at least one of the thermoplastic resin dispenser, the sensor, and the additive dispensing system.

54. The system of claim 50, wherein the thermoplastic resin includes polyethylene terephthalate (PET).

55. The system of claim 50, wherein the thermoplastic resin further includes post-consumer recycled (PCR) resin.

56. The system of claim 50, wherein the sensor is configured to measure the realized visual parameters through the part.

57. The system of claim 50, wherein the sensor is configured to measure the realized visual parameters through the part, the part including a closure for a container.

58. The system of claim 50, wherein the sensor is configured to measure the realized visual parameters through at least one wall of the part.

59. The system of claim 50, wherein the sensor is a solid state sensor including an emitter and a receiver.

60. The system of claim 50, wherein the sensor is configured to detect visible, ultraviolet, or infra-red light.

61. The system of claim 50, wherein the sensor uses fiber optic cables to transmit and receive light.

62. The system of claim 50, wherein the realized visual parameters include the following color space values: (L*a*b*) and a yellowness index (YI).

63. The system of claim 50, wherein the target visual parameters correspond to reference visual parameters.

64. The system of claim 50, wherein the thermoplastic resin dispenser is configured to dispense the additive into the injection molding machine at a screw or at least one feed-throat of the injection molding machine.

65. The system of claim 50, further comprising dispensing the additive directly into the thermoplastic resin.

66. The system of claim 50, wherein the sensor is configured to measure the realized visual parameters of the part at one of the following locations: the injection molding machine; end of arm tooling; and a conveyor.

67. The system of claim 50, wherein the injection molding machine is configured to mix the additive and the thermoplastic resin before forming the part.

68. The system of claim 50, wherein the injection mold is configured for simultaneously molding at least forty-eight parts.

69. The system of claim 50, wherein the additive is a colorant.

70. The system of claim 50, wherein the sensor is configured to measure the realized visual parameters by reflecting a light off of the part.

71. The system of claim 50, wherein the thermoplastic resin includes high density polyethylene (HDPE).

72. The system of claim 50, wherein the thermoplastic resin includes high polypropylene (PP).

73. The system of claim 50, wherein the control module is further configured to continuously compare the realized visual parameters of subsequent parts formed by the injection molding machine to the target visual parameters, and determine whether the realized visual parameters of subsequent parts are within the predetermined acceptable range of the target visual parameters.

74. The system of claim 73, wherein if the realized visual parameters of any of the subsequent parts are outside the predetermined acceptable range of the target visual parameters, the control module is configured to adjust the additive to a further modified amount estimated by the control module to achieve the target visual parameters.
